(19) United States
(12) Patent Application Publication
(10) Pub. No.: US 2014/0047465 A1
(43) Pub. Date: Feb. 13, 2014

(54) MULTI-MEDIA AD TARGETING AND CONTENT RECOMMENDATION WITH VIEWER IDENTITY DETECTION SYSTEM

(71) Applicant: WebTuner, Corporation, Redmond, WA (US)

(72) Inventors: Eduard Zaslavsky, Issaquah, WA (US); Arthur Vaysman, San Jose, CA (US)

(73) Assignee: WebTuner, Corporation, Redmond, WA (US)

(21) Appl. No.: 13/960,959

(22) Filed: Aug. 7, 2013

Related U.S. Application Data
(60) Provisional application No. 61/680,464, filed on Aug. 7, 2012.

(51) Int. Cl. H04N 21/81; H04N 5/44

(52) U.S. Cl. CPC H04N 21/812; H04N 5/4403
USPC 725/12; 348/734

(57) ABSTRACT

Systems and methods for identifying a viewer and determining at least one of a plurality of media to display to the viewer on a display device are disclosed. The system comprises an input device, at least one sensor embedded in the input device, a first processor in electronic communication with the input device, and a second processor in electronic communication with the first processor. Software executing on the first processor obtains behaviometrics measurement data from the input device, determines the identity of the viewer, obtains viewer behavior data for the identified viewer, and exports the identity and viewer behavior data to the second processor. Software executing on the second processor receives the identity and viewer behavior data from the first processor, determines at least one of a plurality of media to display to the viewer, and renders the at least one media on the display device.

### REFERENCE TO RELATED APPLICATIONS

This application claims priority to U.S. Provisional Application No. 61/680464, filed Aug. 7, 2012, entitled “Multi-Media Ad Targeting and Content Recommendation with Viewer Identity Detection System,” and is hereby specifically and entirely incorporated by reference.

### BACKGROUND

1. Field of the Invention

The invention is directed to systems and methods of targeting advertisements, specifically, the invention is directed to multi-media delivery systems for connection to a television display

2. Background of the Invention

Multi-media delivery systems, such as PayTV services, rely on advertisement (ad) revenue. Increased in ad revenue depend on the ability of such systems to deliver targeted ads, maintain or increase the time viewers spend consuming content, empower viewers to consume content more efficiently (i.e. spending less time on browsing, searching, and selecting desirable content and more time on the actual consumption of the desirable content). To deliver targeted ads, systems need to identify viewers, match the viewers against their viewer profile, and pair each viewer with the available ad inventory. Content may refer to a television (TV) program, a movie, an interactive game, a video-on-demand program, a program stored on a digital video recorder (DVR), an audio program, an advertisement, a website, or another consumable media.

To maintain or even increase time viewers spend consuming content, as well as, to increase efficiency of content consumption, systems need to assist viewers with choosing from a possibly overwhelming choice of content. To assist viewers with the overwhelming content choice, a system should offer effective content recommendations. Effective content recommendation capability can be provided by a system if and when the system is aware of who is currently consuming the content. In other words, a system should be able to identify viewers to better assist the viewers to more efficiently browse, search for, and select content.

An additional benefit for a system that can identify viewers is viewers spend less time browsing, searching for, and selection desirable content and more time consuming the desirable content, further increasing the amount and effectiveness of targeted ad consumption.

Various methods are used by existing or proposed systems to identify viewers, all with various degrees of accuracy. To reduce the time it takes for the system to identify viewers and to improve the system's accuracy, some systems rely on the viewers to identify themselves, either by logging in (e.g. by pressing various key on a remote control) or by proactively submitting biometric data (e.g. by submitting voice samples or swiping a finger over a dedicated optical scanner). However, viewers tend to avoid active submission of their biometric data or participation in a log-in process. Such lack of viewer involvement leads to a lower than desirable number of viewer identifications.

### SUMMARY OF THE INVENTION

The present invention overcomes the problems and disadvantages associated with current strategies and designs and provides new tools and methods of suggesting content and targeting advertisements.

One embodiment of the invention is directed to a behaviometrics measurement system to identify a viewer and determine at least one of a plurality of media to display to the viewer on a display device. The system comprises an input device, at least one passive sensor for behaviometrics measurement embedded in the input device, a first processor in electronic communication with the input device, and a second processor in electronic communication with the first processor. Software executing on the first processor obtains behaviometrics measurement data from the input device, parses the behaviometrics measurement data, determines the identity of the viewer from the parsed behaviometrics measurement data, obtains viewer behavior data for the identified viewer, and exports the identity and viewer behavior data of the viewer to the second processor.

Software executing on the second processor receives the identity and viewer behavior data of the viewer from the first processor, parses the identity and viewer behavior data, determines at least one of a plurality of media to display to the viewer, and exports the at least one media to the first processor.

In a preferred embodiment, the media is at least one of an advertisement or content for display on the display device. Preferably, the media is content for display on the display device and the software executing on the second processor recommends the content to the viewer. The media is preferably an advertisement for display on the display device and the system displays the advertisement injected into content the viewer is currently consuming. In a preferred embodiment, the advertisement is targeted to the viewer.

Preferably, at least one behaviometrics measurement sensor senses at least one of changes in spatial positioning of the input device, motion of the input device, force of buttons pressed on the input device, a fingerprint sensor of a viewer interacting with the input device, and spatial positioning and motion of a viewer. At least one sensor preferably obtains the behaviometrics measurement data without the viewer actively providing the biometric data.

In a preferred embodiment, the viewer behavior data is at least one of history of content a viewer consumed in the past, when the viewer consumed the content, and actions taken by the viewer while the content was consumed. Preferably, at least one sensor is at least one of a force sensor, a fingerprint sensor, an accelerometer, a gyroscope, and a magnetic field sensor. Preferably, the second processor is housed in one of a set-top-box, a media player, a television, a computer, a tablet, or a hand-held media device.

Another embodiment of the invention is directed to a method of identifying a viewer and determining at least one of a plurality of media to display to the viewer on a display device. The method comprises, at least one processor, obtaining behaviometrics measurement data from an input device, parsing the behaviometrics measurement data, determining the identity of the viewer from the parsed behaviometrics measurement data, obtaining viewer behaviometrics measurement data for the identified viewer, parsing the identity and viewer behaviometrics measurement data, determining at least one of a plurality of media to display to the viewer from the parsed data, and exporting the at least one media for display on the display device.

Preferably, the media is at least one of an advertisement or content for display on the display device. In the preferred embodiment, the media is content for display on the display device, further comprising recommending the content to the viewer. The media is preferably, an advertisement for display on the display device, further comprising displaying the advertisement with the content the viewer is currently consuming. Preferably, the advertisement is targeted to the viewer.

Preferably, the step of obtaining behaviometrics measurement data from an input device comprises sensing at least one of changes in spatial positioning of the input device, motion of the input device, force of buttons pressed on the input device, a fingerprint sensor data of a viewer interacting with the input device, and spatial positioning and motion of a viewer. In a preferred embodiment, the sensing occurs with the viewer passively providing behaviometrics measurement data with at least one sensor. Preferably at least one sensor is at least one of a force sensor, a fingerprint sensor, an accelerometer, a gyroscope, and a magnetic field sensor.

The viewer behaviometrics measurement data is preferably combined and stored with at least one of history of content a viewer consumed in the past, when the viewer consumed the content, and actions taken by the viewer while the content was consumed. Preferably, the processor is housed in one of a set-top-box, a media player, a television, a computer, a tablet, or a hand-held media device.

Another embodiment of the invention is directed to a remote for a multi-media device. The remote comprises a plurality of buttons, at least one sensor embedded in the remote, a transmitter, and a processor in communication with the plurality of buttons, the at least one biometric sensor, and the transmitter. The at least one sensor obtains the behaviometrics measurement data with a viewer passively providing the behaviometrics measurement data.

Preferably, there are buttons in at least two faces of the remote. In a preferred embodiment, at least one sensor senses at least one of changes in spatial positioning of the input device, motion of the input device, force of buttons pressed on the input device, a fingerprint sensor of a viewer interacting with the input device, and spatial positioning and motion of a viewer. Preferably, at least one sensor is at least one of a force sensor, a fingerprint sensor, an accelerometer, a gyroscope, and a magnetic field sensor.

Other embodiments and advantages of the invention are set forth in part in the description, which follows, and in part, may be obvious from this description, or may be learned from the practice of the invention.

### DESCRIPTION OF THE DRAWING

The invention is described in greater detail by way of example only and with reference to the attached drawing, in which:

FIG. 1 is a schematic of an embodiment of a remote control.

FIGS. 2-7 are views of an embodiment of a remote control.

FIG. 8 is a schematic of an embodiment of a multi-media adapter.

FIG. 9 is a diagram of an embodiment of the communication flow between the multi-media adapter and backend components.

FIG. 10 is a diagram of an embodiment of an overall system with multiple multi-media adapters communicating with backend components.

### DESCRIPTION OF THE INVENTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention

This invention offers systems and methods for effective ad targeting and content recommending enabled by increased accuracy, speed, and number of viewer identifications. This invention identifies viewers by combining and processing passively obtained viewer behaviometrics measurement data with data from an Audience Measurement System (AMS).

Passively obtained behaviometrics measurement data is preferably collected by a remote control. The passively obtained behaviometrics measurement data can include, but is not limited to, changes in spatial positioning of the remote control, motion of the remote control, force with which the viewer pressed keys (such force can be collected by force sensors embedded into the remote control buttons), viewer's fingerprint recognition (e.g. from an optical, ultrasonic, or capacitance sensor embedded into one or more of the remote control buttons), or a viewer's spatial positioning and motion (e.g. obtained by one or more proximity sensors or a low resolution optical sensor embedded into a television, set top box, or other viewer facing device). The behaviometrics measurement data is obtained passively, without a viewer actively providing the behaviometrics measurement data or entering information. For example, the viewer does not have to actively and consciously swipe their finger over a fingerprint reader, type in a user identifier, or provide a voice sample.

The behaviometrics measurement data is preferably combined with a viewer's AMS data which comprises content, ad, and product consumption data as well as any product ordering data. For example, the AMS can collect data on what viewer consumed or ordered the content (e.g. correlated to content, ad, or product unique identifier), when the viewer consumed or ordered the content (e.g. by logging a timestamp of a beginning of the content consumption, the content's duration, and logging a timestamp and duration of an ordered product), actions taken by the viewer (e.g. volume up or down, mute, fast forward, pause, or other key presses related to product placement, product promotions, or product purchases).

Combining the behaviometrics measurement data with data from the AMS via known data mining and data processing algorithms provides substantially improved accuracy, speed, and number of positive viewer identifications over existing systems.

The instant system is preferably able to more effectively generate ad revenue from targeted ad placement, affiliated fees received from product related transactions, and sales of premium content over existing systems.

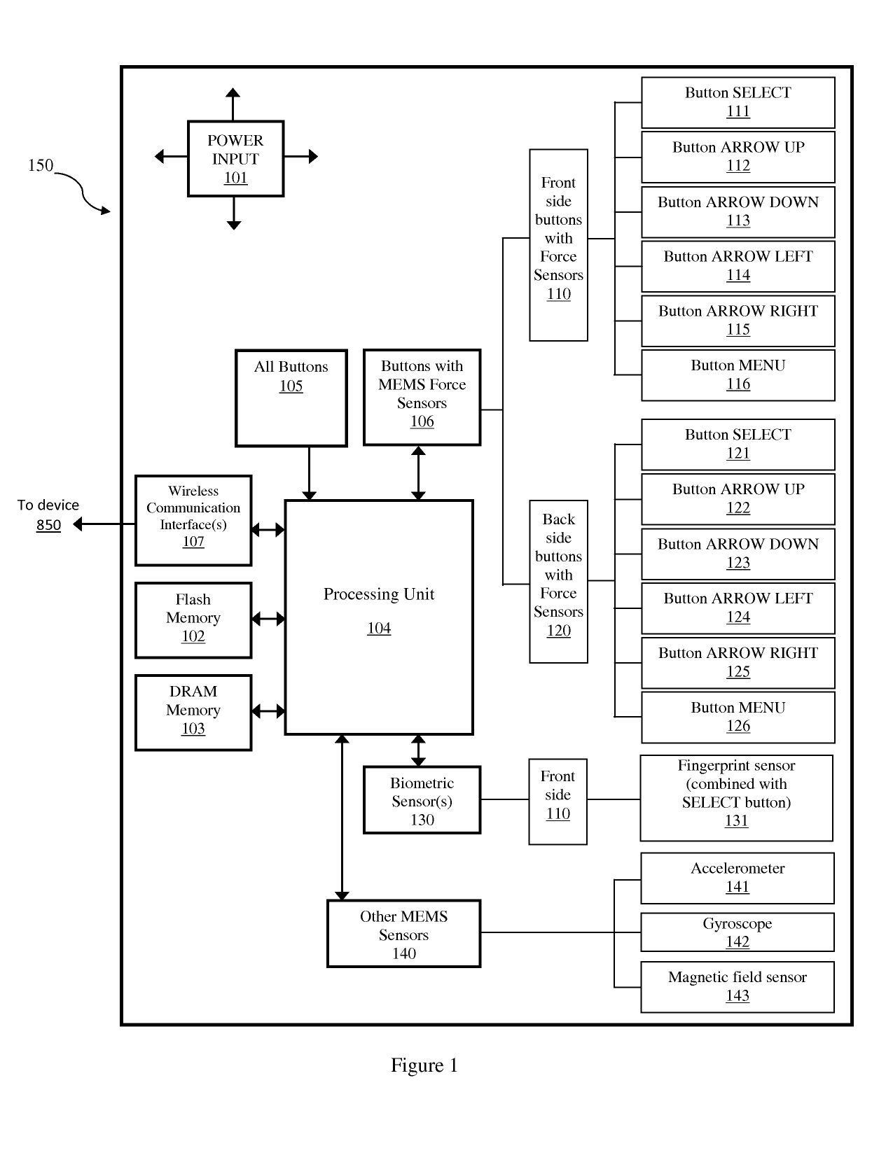

FIG. 1 depicts a schematic of a preferred embodiment of a computing device housed in a remote control that is capable of capturing, storing, processing, and transmitting passively obtained behaviometrics measurement data. Remote control 150 and its components are preferably powered by power input 101. Power input 101 is preferably a rechargeable or disposable battery. A viewer preferably uses remote control 150 to direct functions of multi-media adapter 850 (or another media device) used to access a multi-media delivery service. During normal use of remote control 150 (e.g. lifting, moving, and/or pressing buttons on remote control 150), the viewer communicates behaviometrics measurement data. For example, when remote control 150 is lifted or otherwise moved, remote control 150 collects data from at least one of gyroscope 142, accelerometer 141, magnetic field sensor 143, or another MEMS (microelectromechanical systems) sensor 140. The data is passed to processing unit 104, wherein the data is parsed and stored in flash memory 102 or DRAM memory 103 for later transmission to device 850.

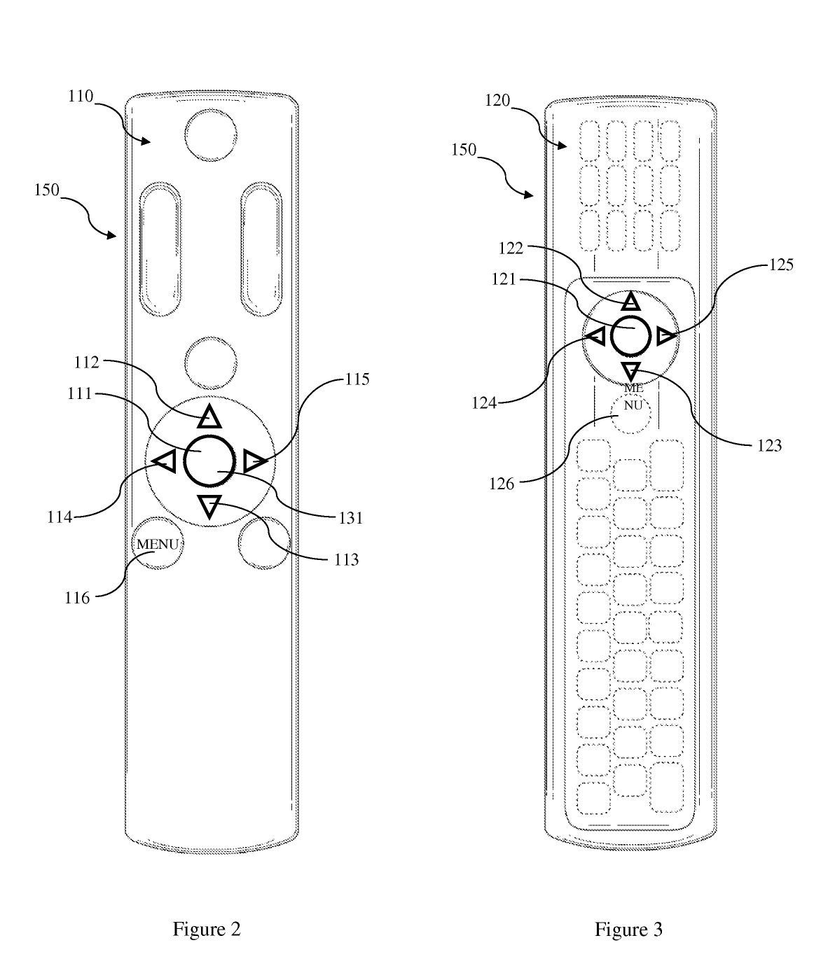

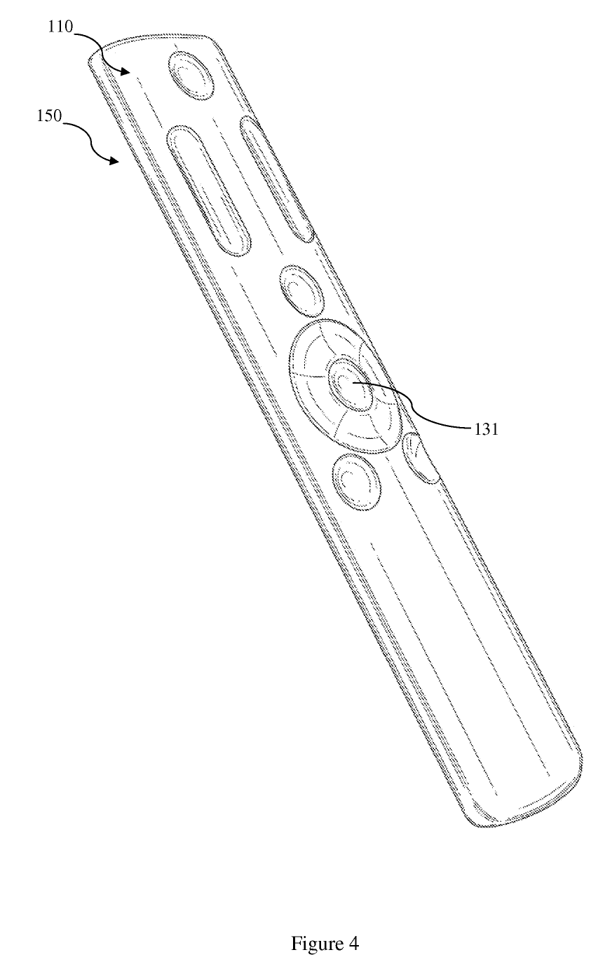

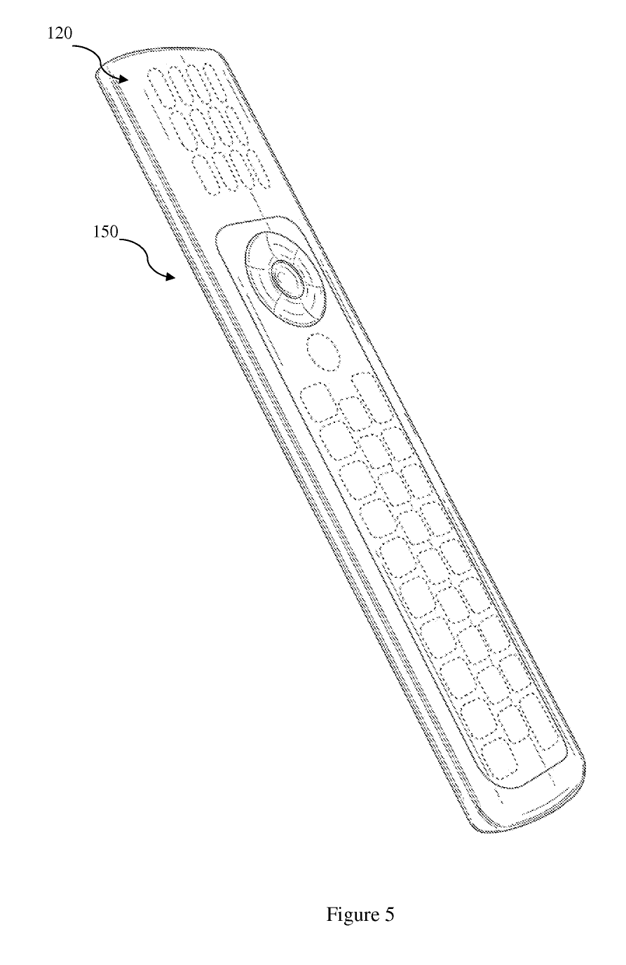

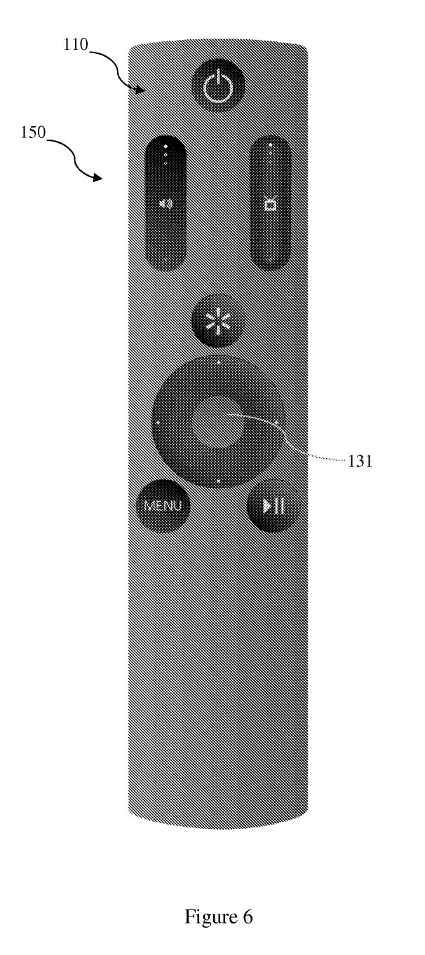

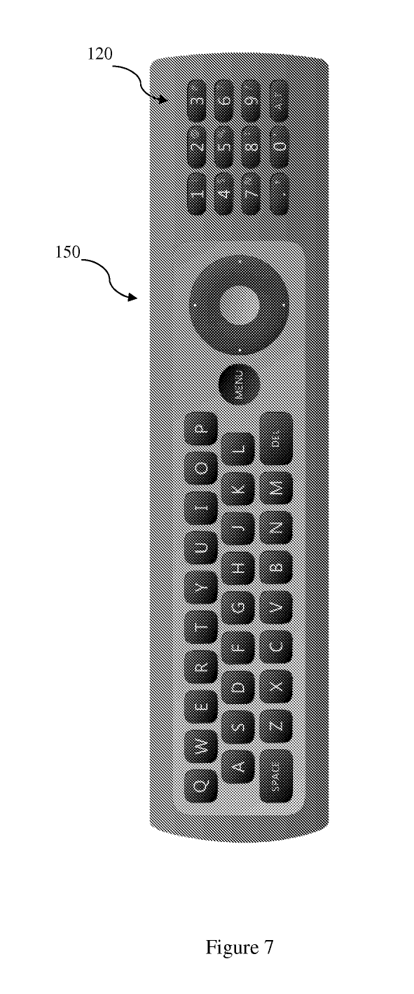

Additionally, in the preferred embodiment, subset of All Buttons 105 includes Buttons with MEMS Force sensors 106, comprised of Front side buttons with Force Sensors 110 and Back side buttons with Force Sensors 120. When keys 111-116 on Front side buttons with Force Sensors 110 (as depicted in FIGS. 2, 4, and 6) and/or keys 121-126 on Back side buttons with Force Sensors 120 (as depicted in FIGS. 3, 5, and 7) are pressed, the data associated with the force exerted by the viewer is collected by MEMS force sensors 106 and passed to processing unit 104 for parsing and storage. Furthermore, in the preferred embodiment, when a viewer presses select button 111 (or another button embedded with a behaviometrics measurement sensor 130) with his or her finger, an embedded fingerprint sensor 131 collects and passes fingerprint information to processing unit 104 for parsing and storage.

In the preferred embodiment, processing unit 104 uses embedded software to process data collected from sensors 106, 130, and 140. Processing unit 104 processes the data, packages the data, and sends the data to multi-media adapter 850 through wireless communication interface 107. Preferably, wireless communication interface 107 is an infrared or IEEE 802.15 interface.

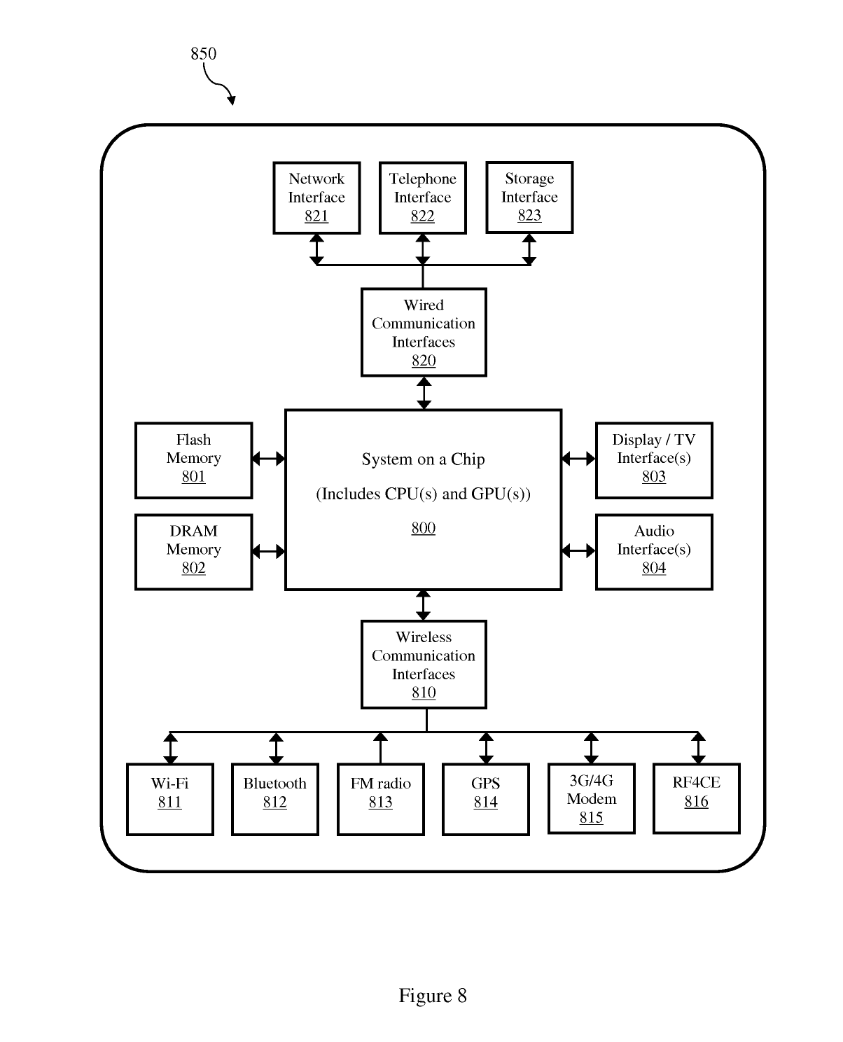

FIG. 8 depicts an embodiment of a schematic of a multi-media adapter 850. Multi-media adapter 850 can be a set-top-box, a computer, a smart TV, a tablet, a hand-held device, or another media player. In the preferred embodiment, multi-media adapter 850 comprises a system on a chip (SoC) 800. The SoC 800 preferably integrates multiple components of a computer or other electronic system into a single chip. It may contain digital, analog, mixed-signal, and radio-frequency functions all on a single chip substrate. SoC 800 preferably incorporates a central processing unit (CPU), a graphics processing unit (GPU), and a system bus that couples various system components including the system memory, dynamic random access memory (RAM) 802 and flash memory 801, to the SoC 800. The system bus may be one of several types of bus structures including a memory bus or memory controller, a peripheral bus, or a local bus using one of a variety of bus architectures. A basic input/output (BIOS) stored in flash memory 801 or the like, may provide the basic routine that helps to transfer information between elements within multi-media adapter 850, such as during start-up. The drives and the associated computer readable media provide nonvolatile storage of computer readable instructions, data structures, program modules and other data for multi-media adapter 850. The basic components are known to those of skill in the art and appropriate variations are contemplated.

Although the exemplary environment described herein employs flash memory, it is appreciated by those skilled in the art that other types of computer readable media which can store data that are accessible by a computer, such as magnetic cassettes, hard drives, digital versatile disks, cartridges, random access memories (RAMs), read only memory (ROM), a cable or wireless signal containing a bit stream and the like, may also be used in the exemplary operating environment.

Multi-media adapter 850 preferably further includes both a wired communications interface 820 and a wireless communications interface 810. Interfaces 820 and 810 are able to connect to, for example, the Internet 821, one or more Local Area Networks (“LANs”) 811, one or more Metropolitan Area Networks (“MANs”), one or more Wide Area Networks (“WANs”), one or more Bluetooth networks 812, one or more radios 813, one or more GPS systems 814, one or more 3G or 4G modems 815, one or more RF4CE (Radio Frequency for Consumer Electronics) systems 816, one or more Intranets, one or more telephone networks 822, one or more storage interfaces 823, etc. Furthermore, interfaces 820 and 810 may also connect to distributed computing environments where tasks are performed by local and remote processing devices that are linked (either by hardwired links, wireless links, or by a combination thereof) through a communications network. In a distributed computing environment, program modules may be located in both local and remote memory storage devices.

To enable user interaction with multi-media adapter 850, multi-media adapter 850 can receive input from a number of input mechanisms in addition to remote control 150, such as a microphone for speech, a touch-sensitive screen for gesture or graphical input, a keyboard, a mouse, motion input, RJ-45, USB, and so forth. In some instances, multimodal systems enable a viewer to provide multiple types of input to communicate with the multi-media adapter 850. There is no restriction on the invention operating on any particular hardware arrangement and therefore the basic features here may easily be substituted for improved hardware or firmware arrangements as they are developed.

Multi-media adapter 850 further includes at least one output port 803 and 804. Output port 803, for example connects multi-media adapter 850 to a TV while output port 804 connects to a speaker. Preferably, output ports 803 and 804 are one of an HDMI port, optical audio port, serial port, USB port, networking port, s-video port, coaxial cable port, composite video, composite audio, and/or VGA port. In preferred embodiments, multi-media adapter 850 may also include additional auxiliary components (e.g. power management devices or digital audio convertors).

For clarity of explanation, the illustrative system embodiments are presented as comprising individual functional blocks. The functions these blocks represent may be provided through the use of either shared or dedicated hardware, including, but not limited to, hardware capable of executing software. For example the functions of one or more processors presented in the figures may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

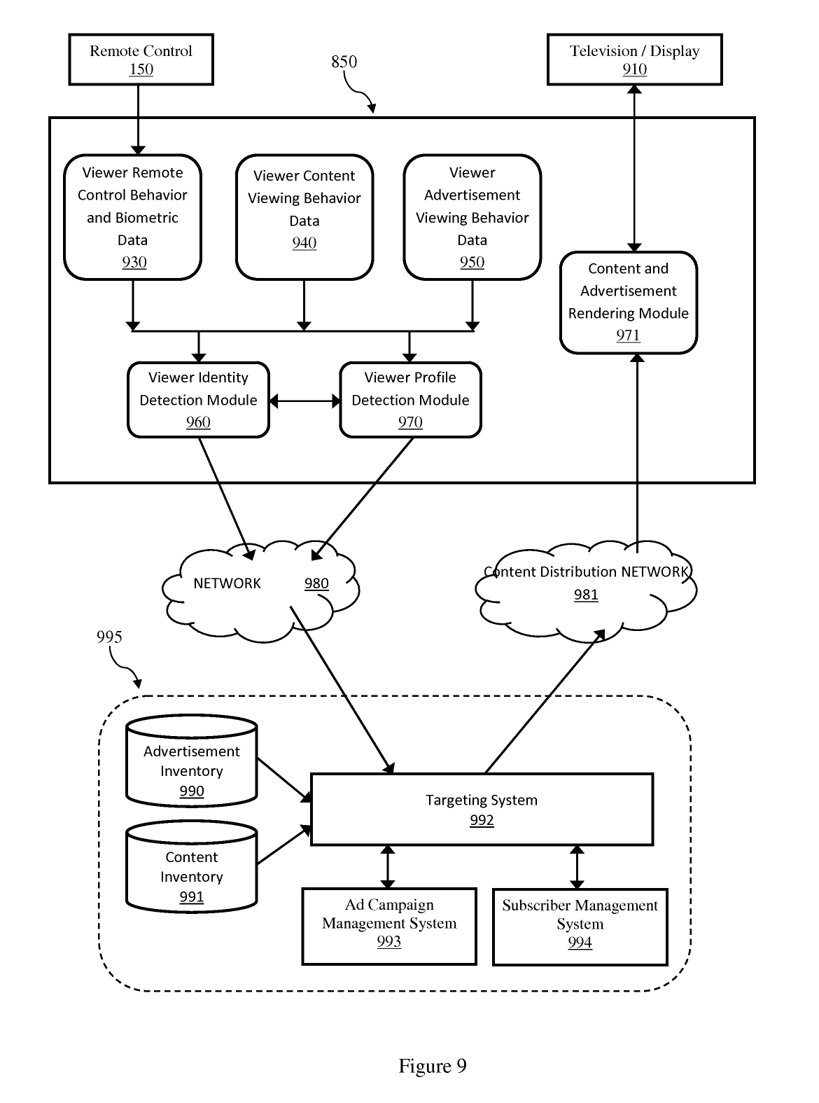

FIG. 9 depicts an embodiment of a functional diagram of components involved in an embodiment of the delivery of targeted advertisements and content recommendations to an identified viewer based on the passively obtained viewer behaviometrics measurement data and AMS data. Remote control 150 sends passive behaviometrics measurement data 930 to viewer identity detection module 960 and viewer profile detection module 970. Preferably identity detection module 960 and viewer profile detection module 970 also receive data from viewer content viewing behavior database 940 and viewer advertisement viewing behavior database 950. Identity detection module 960 and viewer profile detection module 970 process the received data and pass the processed data to backend 995 via network 980. Targeting system 992 in backend 995 receives the data from identity detection module 960 and viewer profile detection module 970 and determines a viewer's profile based on the historic data. Targeting system 992 then uses ad campaign management system 993 to determine which ad from advertisement inventory database 990 to deliver to the viewer's TV/display 910 via content distribution network 981 and content and advertisement rendering module 971. Subscriber Management System 994 is used to link the identity of the viewer currently accessing device 850 with content and advertisement rendering module 971.

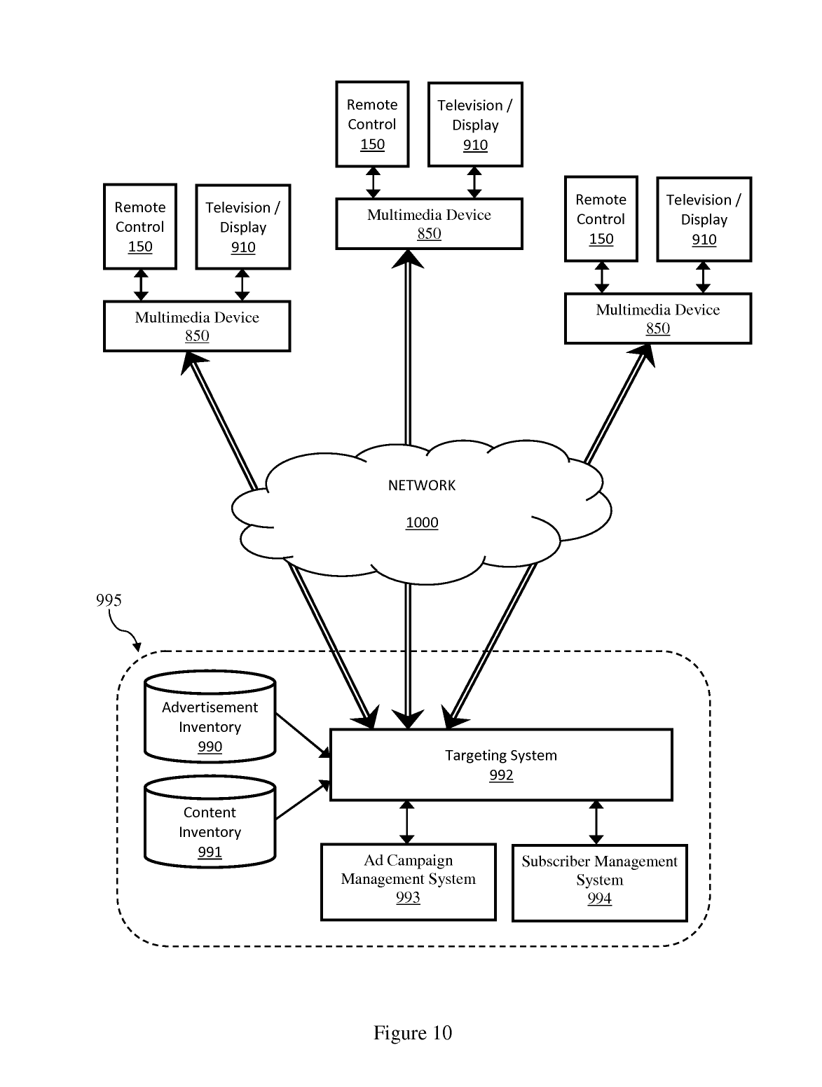

FIG. 10 depicts an embodiment of a backend 995 simultaneously serving multiple multi-media adapters 850, each of which collects behaviometrics measurement data from remote controls 150, processes the data, and sends the data to backend 995 via network 1000. Backend 995 collects behaviometrics measurement data and audience measurement data in targeting system 992 to capture traits and characteristics of a particular viewer. Once the necessary amount of viewer data is collected and processed to make a determination, the system uses the information to attempt to identify the viewer in each usage session in order to determine which ad in advertisement inventory 990 to insert into content delivered from content inventory 991 via network 1000 to multi-media adapter 850 and then to the viewer's TV/display device 910.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising of” includes the terms “consisting of” and “consisting essentially of.”

1. A behaviometrics measurement system to identify a viewer and determine at least one of a plurality of media to display to the viewer on a display device, comprising:
an input device;
at least one passive sensor for behaviometrics measurement embedded in the input device;
a first processor in electronic communication with the input device;
a second processor in electronic communication with the first processor;
software executing on the first processor, wherein the software:
obtains behaviometrics measurement data from the input device;
parses the behaviometrics measurement data;
determines the identity of the viewer from the parsed behaviometrics measurement data;
obtains viewer behavior data for the identified viewer; and
exports the identity and viewer behavior data of the viewer to the second processor; and
software executing on the second processor, wherein the software:
receives the identity and viewer behavior data of the viewer from the first processor;
parses the identity and viewer behavior data;
determines at least one of a plurality of media to display to the viewer; and
exports the at least one media to the first processor.

2. The system of claim 1, wherein the media is at least one of an advertisement or content for display on the display device.

3. The system of claim 2, wherein the media is content for display on the display device and the software executing on the second processor recommends the content to the viewer.

4. The system of claim 2, wherein the media is an advertisement for display on the display device and the system displays the advertisement injected into content the viewer is currently consuming.

5. The system of claim 4, wherein the advertisement is targeted to the viewer.

6. The system of claim 1, wherein at least one behaviometrics measurement sensor senses at least one of changes in spatial positioning of the input device, motion of the input device, force of buttons pressed on the input device, a fingerprint sensor of a viewer interacting with the input device, and spatial positioning and motion of a viewer.

7. The system of claim 1, wherein at least one sensor obtains the behaviometrics measurement data without the viewer actively providing the biometric data.

8. The system of claim 1, wherein the viewer behavior data is at least one of history of content a viewer consumed in the past, when the viewer consumed the content, and actions taken by the viewer while the content was consumed.

9. The system of claim 1, wherein at least one sensor is at least one of a force sensor, a fingerprint sensor, an accelerometer, a gyroscope, and a magnetic field sensor.

10. The system of claim 1, wherein the second processor is housed in one of a set-top-box, a media player, a television, a computer, a tablet, or a hand-held media device.

11. A method of identifying a viewer and determining at least one of a plurality of media to display to the viewer on a display device, comprising at least one processor:
obtaining behaviometrics measurement data from an input device;
parsing the behaviometrics measurement data;
determining the identity of the viewer from the parsed behaviometrics measurement data;
obtaining viewer behaviometrics measurement data for the identified viewer;
parsing the identity and viewer behaviometrics measurement data;
determining at least one of a plurality of media to display to the viewer from the parsed data; and
exporting the at least one media for display on the display device.

12. The method of claim 11, wherein the media is at least one of an advertisement or content for display on the display device.

13. The method of claim 12, wherein the media is content for display on the display device, further comprising recommending the content to the viewer.

14. The method of claim 12, wherein the media is an advertisement for display on the display device, further comprising displaying the advertisement with the content the viewer is currently consuming.

15. The method of claim 14, wherein the advertisement is targeted to the viewer.

16. The method of claim 11, wherein the step of obtaining behaviometrics measurement data from an input device comprises sensing at least one of changes in spatial positioning of the input device, motion of the input device, force of buttons pressed on the input device, a fingerprint sensor data of a viewer interacting with the input device, and spatial positioning and motion of a viewer.

17. The method of claim 16, wherein the sensing occurs with the viewer passively providing behaviometrics measurement data with at least one sensor.

18. The method of claim 16, wherein at least one sensor is at least one of a force sensor, a fingerprint sensor, an accelerometer, a gyroscope, and a magnetic field sensor.

19. The method of claim 11, wherein the viewer behaviometrics measurement data is combined and stored with at least one of history of content a viewer consumed in the past, when the viewer consumed the content, and actions taken by the viewer while the content was consumed.

20. The method of claim 11, wherein the processor is housed in one of a set-top-box, a media player, a television, a computer, a tablet, or a hand-held media device.

21. A remote for a multi-media device, comprising:
a plurality of buttons;
at least one sensor embedded in the remote;
a transmitter;
a processor in communication with the plurality of buttons, the at least one biometric sensor, and the transmitter;
wherein the at least one sensor obtains the behaviometrics measurement data with a viewer passively providing the behaviometrics measurement data.

22. The remote of claim 21, wherein there are buttons in at least two faces of the remote.

23. The remote of claim 21, wherein at least one sensor senses at least one of changes in spatial positioning of the input device, motion of the input device, force of buttons pressed on the input device, a fingerprint sensor of a viewer interacting with the input device, and spatial positioning and motion of a viewer.

24. The system of claim 21, wherein at least one sensor is at least one of a force sensor, a fingerprint sensor, an accelerometer, a gyroscope, and a magnetic field sensor.
